(19) United States
(12) Patent Application Publication
(10) Pub. No.: US 2004/0220870 A1
(43) Pub. Date: Nov. 4, 2004

(54) Method and system for improved automated trading of swap contracts

(76) Inventors: Jonas Lundberg, Stockholm (SE); Ulf Ahlenius, Bromma (SE)

Correspondence Address: NIXON & VANDERHYE, PC, 1100 N GLEBE ROAD, 8TH FLOOR, ARLINGTON, VA, 22201-4714, US

(21) Appl. No.: 10/424,997

(22) Filed: Apr. 29, 2003

(51) Int. Cl. G06F 17/60

(52) U.S. Cl. 705/37

(57) ABSTRACT

In an automated exchange system interest rate Swap contracts are traded. The system supports formation of a combined Swap contract while matching only one leg of the Swap contract. The system is processing efficient and at the same time very user friendly for trading.

### TECHNICAL FIELD

The present invention relates to an automated exchange system designed for trading Swap contracts and in particular interest rate Swap contracts.

### BACKGROUND OF THE INVENTION AND PRIOR ART

Swaps are in general instruments that swap one financial instrument for another. In the case of interest rate Swaps, one cash flow is traded in exchange for another cash flow. The most commonly traded interest rate Swap contract is a so-called plain vanilla or generic Swap contract. This Swap contract is a contract where one party pays a fixed future cash flow in return for a future floating cash flow. The fixed cash flow is determined at the start of the contract and the floating cash flow is determined from some kind of index. The parties entering into a Swap transaction are in most case parties of the Interbank market, where in most cases all parties are deemed to have the same credit rating. A Swap contract will, by its nature, be a credit instrument since there will be a counter-party risk involved between the parties of the Swap.

Interbank offered rates (IBOR) rates are used as reference indexes in most Swap contracts, even more complex Swap contracts. The IBOR rates are based on the interest rate that the banks can borrow or lend between each other also called the inter-bank market.

The index can for example be the six-month LIBOR index interest rate or the some other reference rate. LIBOR is the abbreviation for London Interbank Offered Rate, and is the interest rate offered by a specific group of London banks for U.S. dollar deposits of a stated maturity. LIBOR is used as a base index for setting rates of some adjustable rate financial instruments. The Interbank offered rates (IBOR) are usually used with three, six or twelve months reset periods.

Nowadays Swap contracts are more liquid than in the past, i.e. they are traded more frequently. One reason behind this is the fact that the governments are issuing fewer bonds to finance their budget. However, the trading in Swap contracts is still very much limited to voice trading over the telephone. A difference between credit instruments compared to government bonds is the credit risk associated with the instruments. A government instrument can be said to have no or very little risk whereas other instruments are associated with a risk.

As a result of the fewer number of government bonds the credit instruments have become more and more important lately. In the past the credit instruments used to be compared with the government yield curve but that has changed. Today investors often use the Swap curve for valuing credit instruments. The Swap curve is the yield curve illustrating the relationship of Swap rates at various maturities. One reason for this behavior is that the Swap curve is also a credit curve and credit curves tend to move together.

For example, in a case of a crisis investors tend to run for safe havens, i.e. sovereign debt, and the yield of these instruments fall but the credit curve usually rise. Thus, if the credit instrument is measured against the government curve this will give a wrong valuation. The Swap curve however will also spread against the government curve.

Thus, the correlation between the Swap and a credit curve is usually better than the correlation between the government and the credit curve. Due to i.a. this fact the Swap curve has become more and more important in the trading of interest rate instruments, and the trend is towards an even higher demand for trade in Swap instruments.

Although there are automated systems for trading Swap contracts and interest rate Swap contracts in particular; most of such contracts are as stated above still traded manually over the phone. The reason for this is at least partly the lack of an efficient trading system that is easy to use and which at the same time is able to cope with the real time constraints in terms of processing capacity of an automated exchange system.

### SUMMARY

It is an object of the present invention to provide a method and a system whereby the current way of trading Swap contracts is made more flexible and at the same time reduce the computational load on the computer used in the matching process.

It is a further object of the present invention to provide a method and a system whereby trading is facilitated for the parties taking part in the trade.

These objects and others are obtained by a method and a system for trading interest rate Swaps wherein all current bids and offers for a group of interest rate contracts are displayed together with a corresponding reference contract, and wherein a matched offer or bid in one of the displayed group of contracts automatically implies a simultaneous trade in the reference contract. Thereby creating a Swap contract including the displayed group contract and the displayed reference contract.

In a preferred embodiment the reference contract is an interest rate contract paying a floating interest rate and preferably the current rate of the floating interest rate contract is displayed in the same view as the other information.

Thus, when a trade is made in one of the traded legs of an implied Swap there will always be a corresponding trade in an additional instrument that may be termed reference instrument. For example, in the case of a so-called plain vanilla or generic Swap contract, the reference instruments will be the moving leg of the trade and the legs in which a trade is performed will be the possible fixed income terms.

### BRIEF DESCRIPTION OF THE DRAWINGS

The present invention will now be described in more detail by way of non-limiting examples and with reference to the accompanying drawings, in which:

FIG. 1 is an overall view of a central computer system for matching interest rate instruments and associated units.

FIG. 2 is a view of a graphical interface to the computer system of FIG. 1.

FIG. 3 is a flowchart illustrating process steps performed by the system when processing data relating to a trade in an interest rate instrument.

FIG. 4 illustrates the set up of a new instrument.

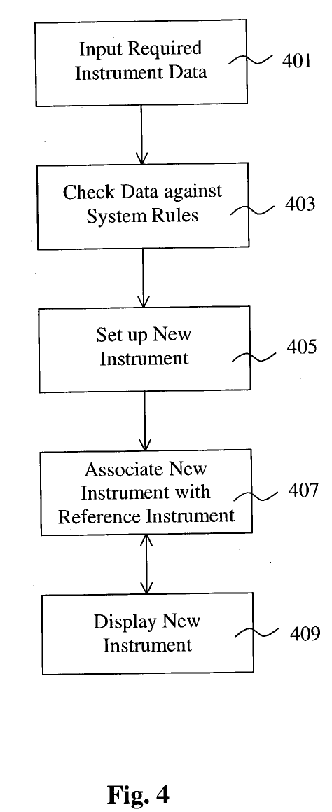

### DETAILED DESCRIPTION

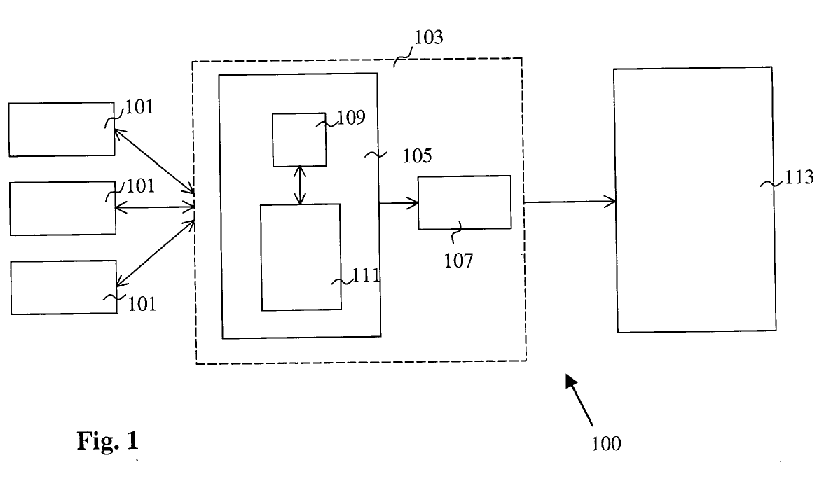

In FIG. 1, a general view of an automated exchange system 100 is shown. The system 100 comprises a number of remote terminals 101 all connected to a central computer server system 103 comprising a matching unit 105 including a computer processor 109 and an associated order book (memory) 111. The central computer server 103 is loaded with suitable software, such as the CLICK TM software sold by OM Technology AB, Sweden, and forms an automated exchange having all features and functionality of a conventional automated exchange. The remote terminals 101 are designed to send data to and receive data from the central computer server 103. The terminals 101 are further designed to provide an interface for investors, such as broker firms etc., trading contracts including interest rate contracts at the automated exchange. The matching of orders input in such a system is performed in the central computer server by the unit 105 designed for this task. The system 103 further comprises a deal capture module 107. The module 107 is responsible for performing tasks such as receiving and register a deal in a designated database and reply to requests relating to closed deals. Also, if a deal needs to be cancelled/altered, this is normally performed in the deal capture module. The system 103 may also be linked to other associated systems, such as a position keeping system 113. In particular the system in FIG. 1 is designed to provide an efficient marketplace for trading of interest rate Swap contracts.

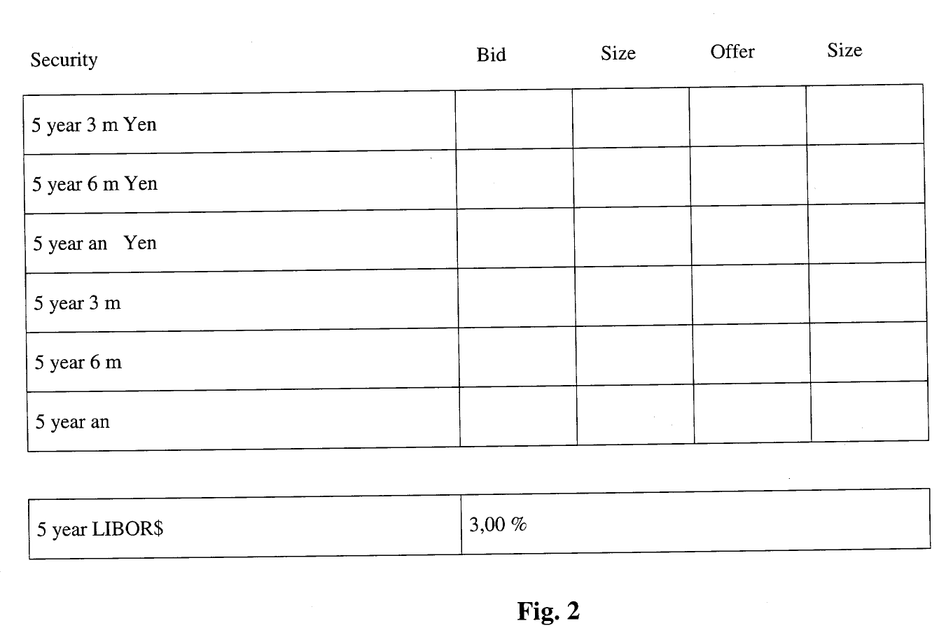

In FIG. 2, an exemplary screen shot when trading an interest Swap contract in the system depicted in FIG. 1 is shown. In FIG. 2, the leftmost column labeled security displays the name of a number of different interest rate instruments. The remaining columns displays, from left to right:

The current best bid for each instrument

The size (volume) at the best bid

The current best offer

The size (volume) at the best offer

The bottom line indicates the implied reference contract leg of the Swap that a match in one of the above listed group of contracts will imply as an additional leg in the Swap contract. In this example the implied reference contract is a floating contract, a 5 year LIBOR contract in U.S. dollars. Consequently, the listed traded contracts; here the fixed payment legs of the plain-vanilla Swap are all 5-year contracts. The fixed payment instruments may be U.S. dollar instruments as well as instruments in other currencies, e.g. Japanese Yen. The fixed payments instruments may also have different payment terms, e.g. three-monthly, six-monthly, annually as indicated in FIG. 2.

The reference contract leg displayed at the bottom line is preferably displayed with the current rate it pays in the case it is a floating interest rate contract. In FIG. 2 it is assumed that the current 5-year LIBOR rate is 3.00%

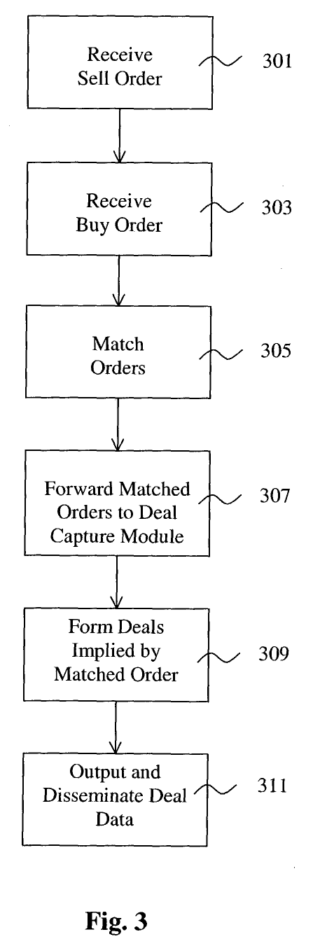

In FIG. 3, a flowchart illustrating exemplary steps performed in the system when trading Interest Swap contracts is depicted. In the example a so-called plain vanilla or generic Swap contract is matched, but other Swap contracts are of course also possible to trade in accordance with the same principles.

First, an order is placed by a first trader. In this example a trader A enters an order to sell a fixed interest rate instrument and at the same time buy a floating rate instrument. For example, an order to sell 100 contracts of a five year fixed interest rate instrument with six-monthly payments and at the same time buy a corresponding number of 5-year floating interest rate instrument contracts. The sell order (and its implied buy order) is then transmitted to the central matching system, where it is received step 301.

Next, a second trader B enters an order to buy a corresponding contract, matching the sell order input by trader A. The buy order is then transmitted to the central matching system. The order is received by the system, step 303.

The orders 301 and 303 transmitted from the first and second trader are, when received by the central system, directed to the matching unit of the central system for matching. In this case, the orders received in steps 301 and 303 match. If there is no direct match an order may be stored in the orderbook of the system for future match against future orders or killed depending on the type of order.

Once matched in the matching unit, step 305, the outcome of the match is forwarded to another entity, preferably a deal capture module as depicted in FIG. 1, step 307. Next, in a step 309, the deal capture module forms the combined Swap contract by adding to the matched fixed interest rate contract leg its implied floating interest rate contract leg. In this example the resulting Swap will be such that trader A will sell 100 contracts at fixed interest rate to trader B and at the same time trader B will sell 100 contracts floating interest rate contracts to trader A.

Finally, the legs of the Swap are output from the deal capture system and disseminated to the market, step 311. If configured to be disseminated to the market. The trade information is preferably disseminated to the trading parties.

Interest rate Swaps have a start date and an end date. If an interest rate Swap is created in the system a start and end date must be specified. If no term code, time or the Swap, suites the trader it is preferred that the system provides for tailor made term codes. I.c. term codes set by the users of the system.

For example, if there exists no interest rate Swap starting in two months and ending two years later, such a Swap may be created by a trader connected to the Swap, i.e. a tailor made interest rate Swap. The corresponding floating interest rate instrument will by the system be set to have the same start date and end date. The floating interest rate legs may for example be based upon 3, 4, 6 or 12 month moving payments. However other terms may be set up. Whenever a trade is made there will be two trades created one in the fixed leg and one in the floating leg.

The system may also be designed to be able to configure the floating leg to have a different start and end date than the fixed leg. If the terms are different the interest rate Swap will be a so-called mismatched interest rate Swap.

When the instruments are created, the new instrument information is disseminated to the market. Thus, everyone in the market place that are allowed to trade in the instruments will be able to input orders in the newly created instruments. Since the instrument is shown to everyone the liquidity of the instrument will be better than if not shown to everyone.

The nominal amount changed in the transaction will preferably be naught since one leg is bought and the other one is sold. An interest rate Swap may preferably have the specified cash flows send out together with the information on the connection When a trade is made, the trade information may be sent to the entire market or only to the parties involved in the trade, depending on the setup for the exchange.

Tailor making of a new fixed interest rate instrument leg in the system is, as described above, possible. When creating a new leg to be traded by the system, it is preferred that the trader/user specifies some parameters. Below a flowchart illustrating steps performed in the system in conjunction with the set up of a new leg is shown. First a number of required parameters relating to the new leg have to be input, step 401. The instrument parameters may for example include start date, length of Swap, cash flow frequency. The information is preferable checked against some rules set up by the exchange, step 403. The rules that the system checks against may include adjustments of cash flow dates, start adjustments, frequency etc.

For example, all cash flows can be adjusted so that all payments are done on settlements dates and that the cash flow sizes are adjusted accordingly. Another example can be that the exchange has restricted the length of the swap to not be more than ten years.

Thereupon the system creates the new instrument, step 405. When setting up the new instrument some information may be inherited from other fixed interest rate contracts similar to the new contract For example, the currency of the payments, the price tick structures, the trading times etc may be inherited

The system then associates the new fixed interest rate contract with a corresponding floating interest rate contract, step 407. For example, a new five-year contract will be associated with a five year floating interest rate contract. Finally, the new Swap is displayed by the system to the system's users in the correct view. In this example the view having the five-year floating interest rate leg as reference leg, step 409. Which is sent out to all traders.

In one preferred embodiment only the information that the new instrument is created is sent out so that those traders that may want to trade the new instrument can query for the new information. This design can be used to save bandwidth.

The method and system as described herein will provide a very efficient system in terms of matching processing. Also the method and system will be easy to use for a person trading in the system thanks to the interface that provides a user with a very good view of the trade he enters.

1. A method of trading a Swap interest rate contract in an automated exchange, the exchange comprising a unit for matching incoming bids and offers input from a number of input terminals connected to the exchange and a memory unit for storing active unmatched bid and offers received by the exchange the method comprising the steps of:
a) receiving a bid/offer for a first contract in an interest rate instrument from a first trading party
b) receiving a corresponding bid/offer matching the bid/offer received in step a) from a second trading party
c) matching the bids and offers received in steps a) and b), respectively
d) adding a second interest rate contract to the bids and offers matched in step c) subsequent to the completion of the matching thereby forming a combined Swap deal comprising the trade of a first interest rate instrument and the trade of a second interest rate instrument between said first and second trading parties.

2. The method of claim 1, wherein said first contract is in an interest rate instrument having fixed payments.

3. The method of claim 1, wherein said second contract is in an interest rate instrument having floating payments.

4. The method of claim 3, wherein the floating payments are based on an Interbank Offered Rate (IBOR).

5. The method of claim 3, wherein the current rate of the floating payments is displayed to the trading parties when they input their bids/offers.

6. The method of claim 1, wherein the first and second trading parties both are parties of an Interbank market.

7. The method of claim1, wherein the system displays to the parties a number of interest rate instruments that can be simultaneously swapped for a particular interest rate instrument and where said number of instruments and said particular instrument are displayed in the same view.

8. The method of claim 7, wherein said first contract is in one instrument of said number of instruments and where said second contract is in said particular instrument.

9. The method of claim 7, wherein said particular interest rate instrument is given in a first currency and where at least one of said number of interest rate instruments given in a second currency other than said first currency.

10. The method of claim 1, wherein a trading party is enabled to set up a new contract to be traded in the system.

11. The method of claim 1, wherein said formation of a combined Swap deal is performed in a deal capture module of the system.

12. An automated exchange for trading interest rate Swap contracts, the exchange comprising a unit for matching incoming bids and offers input from a number of input terminals connected to the exchange and a memory unit for storing active unmatched bid and offers received by the exchange the exchange having
means for receiving a bid/offer for a first contract in an interest rate instrument from a first trading party
means for receiving a corresponding bid/offer matching the bid/offer of the first trading party from a second trading party
means for matching the bids and offers received from said first and second trading parties
means for adding a second interest rate contract to the bids and offers matched subsequent to the completion of the matching thereby forming a combined Swap deal comprising the trade of a first interest rate instrument and the trade of a second interest rate instrument between said first and second trading parties.

13. The exchange of claim 12, wherein said first contract is in an interest rate instrument having fixed payments.

14. The exchange of claim 12, wherein said second contract is in an interest rate instrument having floating payments.

15. The exchange of claim 14, wherein the floating payments are based on an Interbank Offered Rate (IBOR).

16. The exchange of claim 14, further having means for displaying the current rate of the floating payments to the trading parties in conjunction to an input of a bid or offer.

17. The exchange of claim 12, wherein the first and second trading parties both are parties of an Interbank market.

18. The exchange of claim12, wherein the system comprise means for displaying to the parties a number of interest rate instruments that can be simultaneously swapped for a particular interest rate instrument and wherein said means are designed to display said number of instruments and said particular instrument in the same view.

19. The exchange of claim 18, wherein said first contract is in one instrument of said number of instruments and where said second contract is in said particular instrument.

20. The exchange of claim 18, the exchange further having means for trading Swap contracts wherein the different legs of the contracts are in different currencies.

21. The exchange of claim 12, the exchange having means for enabling a trading party to set up a new contract to be traded on the exchange.

22. The exchange of claim 12, wherein said formation of a combined Swap deal is performed in a deal capture module of the exchange system.
